(19) United States
(12) Patent Application Publication
(10) Pub. No.: US 2018/0169877 A1
(43) Pub. Date: Jun. 21, 2018

(54) KITCHEN KNIFE

(71) Applicant: Chia-Ming LIU, Douliou City (TW)

(72) Inventor: Chia-Ming LIU, Douliou City (TW)

(21) Appl. No.: 15/472,790

(22) Filed: Mar. 29, 2017

(30) Foreign Application Priority Data
Dec. 20, 2016 (CN) 201621406690.1

(51) Int. Cl. B26B 3/00; B25G 1/00

(52) U.S. Cl. CPC B26B 3/00; B25G 1/00

(57) ABSTRACT

A kitchen knife includes a hollow handle having a surrounding wall which surrounds an axis in a longitudinal direction and which has an inner wall surface that defines an accommodation chamber therein, a blade connected to a front end of the handle, and a counterweight unit pressed fit in the accommodation chamber, and including a base seat which extends in the longitudinal direction to be in frictional engagement with the inner wall surface, and a plurality of primary counterweight members which are removably disposed on the base seat and which are spaced apart from each other in the longitudinal direction. The weight and weight distribution of the knife are adjustable by varying the number and position of the primary counterweight members on the base seat.

### CROSS-REFERENCE TO RELATED APPLICATION

This application claims priority of Chinese Patent Application No. 201621406690.1, filed on Dec. 20, 2016.

### FIELD

The disclosure relates to a kitchen knife, and more particularly to a kitchen knife with a counterweight unit in a handle to adjust its center of gravity.

### BACKGROUND

A conventional kitchen knife (such as a chef's knife) generally has a fixed weight and weight distribution to be balanced and stable. The kitchen knife for a chief or a commercial user must be sharpened frequently such that the center of gravity of the knife would be moved rearwardly after a period of use, which results in a feeling of discomfort and unsmooth manipulation.

### SUMMARY

Therefore, an object of the disclosure is to provide a kitchen knife that can alleviate at least one of the drawbacks of the prior art.

According to the disclosure, the kitchen knife includes a hollow handle having a surrounding wall which surrounds an axis in a longitudinal direction to have opposite front and rear ends, and which has an inner wall surface that defines an accommodation chamber therein, a blade connected to the front end of the handle and having cutting edge which faces downwardly, and a counterweight unit pressed fit in the accommodation chamber. The counterweight unit includes a base seat which extends in the longitudinal direction to be in frictional engagement with the inner wall surface, and a plurality of primary counterweight members which are removably disposed on the base seat and which are spaced apart from each other in the longitudinal direction.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view illustrating an embodiment of a kitchen knife according to the disclosure;

FIG. 2 is a perspective view of the embodiment;

FIG. 3 is a sectional view taken along line III-III of FIG. 2;

FIG. 4 is a cross-sectional view taken along line IV-IV of FIG. 3;

FIG. 5 is a cross-sectional view taken along line V-V of FIG. 3; and;

FIG. 6 is a sectional view similar to FIG. 3, illustrating the embodiment in a different state of use.

### DETAILED DESCRIPTION

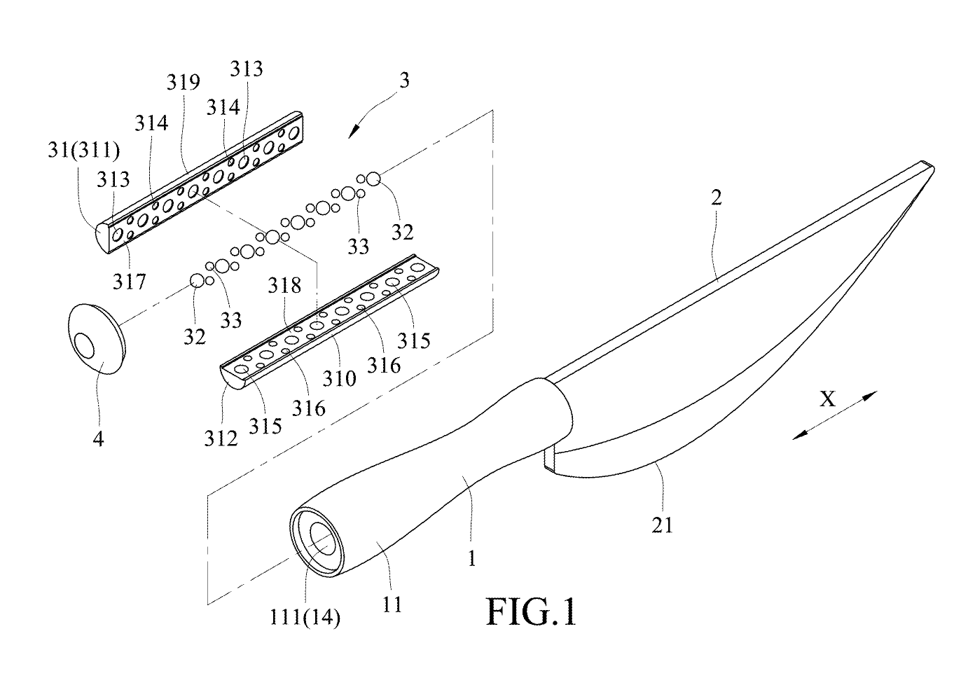

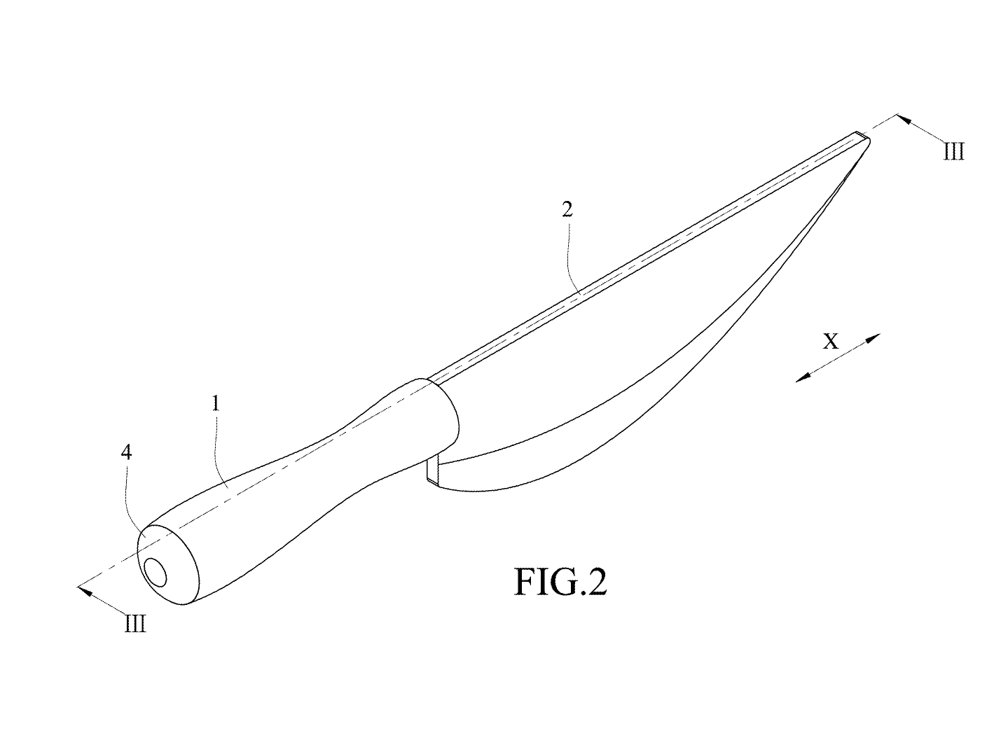

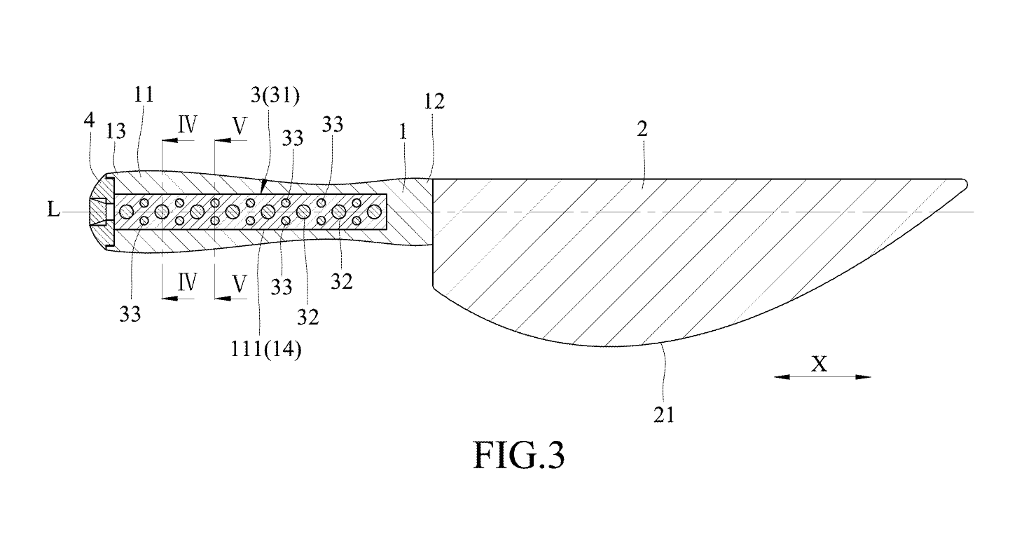

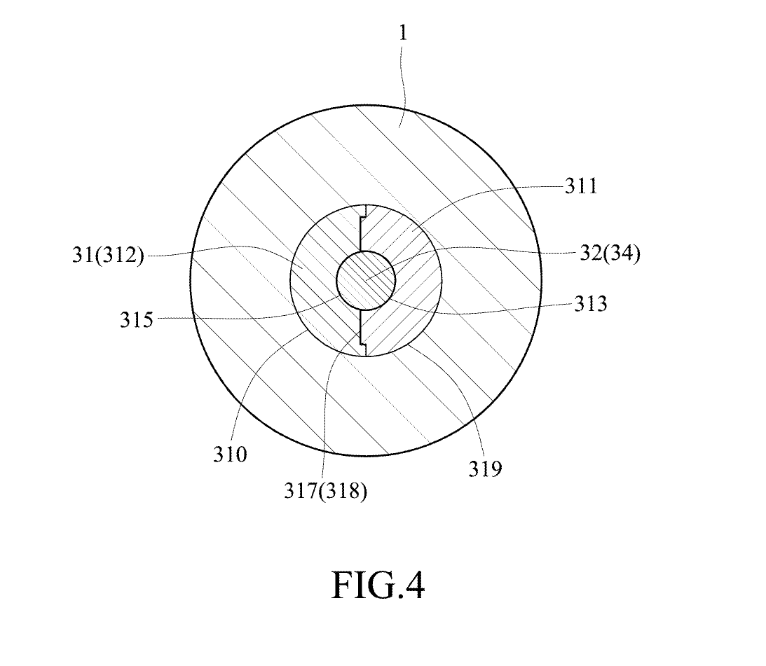

Referring to FIGS. 1 to 4, an embodiment of a kitchen knife according to this disclosure includes a hollow handle 1, a blade 2, a counterweight unit 3 and an end cap 4.

The handle 1 has a surrounding wall 11 which surrounds an axis (L) in a longitudinal direction (X) to have opposite front and rear ends 12, 13, and which has an inner wall surface 111 that defines an accommodation chamber 14 therein. The blade 2 is connected to the front end 12 of the handle 1 and has a cutting edge 21 which faces downwardly and which extends in the longitudinal direction (X).

The counterweight unit 3 is pressed fit in the accommodation chamber 14, and includes a base seat 31 which extends in the longitudinal direction (X) to be in frictional engagement with the inner wall surface 111 of the handle 1, a plurality of primary counterweight members 32 which are removably disposed on the base seat 31 and which are spaced apart from each other in the longitudinal direction (X), and a plurality of secondary counterweight members 33 which are removably disposed on the base seat 31, which are spaced apart from each other in the longitudinal direction (X), and which are alternately arranged with the primary counterweight members 32.

Specifically, the base seat 31 has first and second halves 311, 312 each extending in the longitudinal direction (X). The first and second halves 311, 312 respectively have first and second mating surfaces 317, 318 which confront each other in a transverse direction that is transverse to the longitudinal direction (X). The first and second halves 311, 312 further respectively have first and second outer surfaces 319, 310 which respectively extend from peripheries of the first and second mating surfaces 317, 318 and which are configured to be frictionally engaged with the inner wall surface 111 of the handle 1. The first mating surface 317 has a plurality of first primary recessed halves 313 that are spaced apart from each other in the longitudinal direction (X). The second mating surface 318 has a plurality of second primary recessed halves 315 that are spaced apart from each other in the longitudinal direction (X). Each pair of the first and second primary recessed halves 313, 315 are disposed to mate with each other so as to corporately define a primary recess 34 for accommodating a respective one of the primary counterweight members 32.

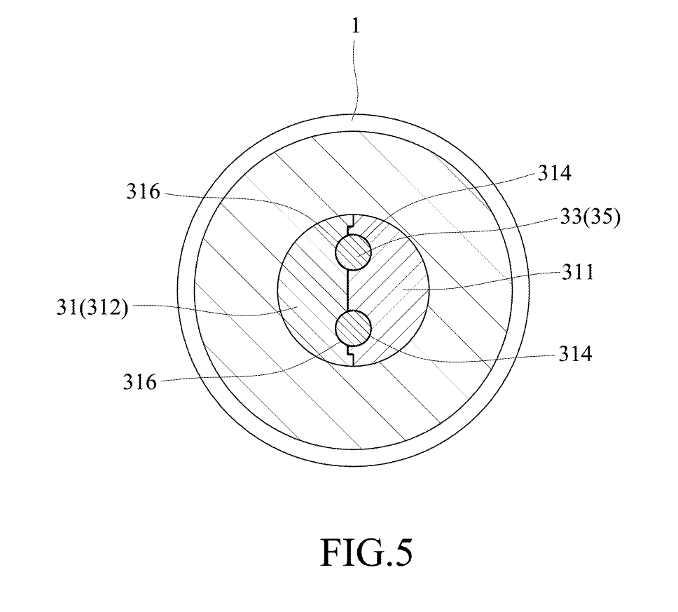

With reference to FIG. 5, the first and second mating surfaces 317, 318 of the first and second halves 311, 312 respectively have a plurality of first secondary recessed halves 314 which are spaced apart from the first primary recessed halves 313 and a plurality of second secondary recessed halves 316 which are spaced apart from the second primary recessed halves 315. Each pair of the first and second secondary recessed halves 314, 316 are disposed to mate with each other so as to corporately define a secondary recess 35 for accommodating a respective one of the secondary counterweight members 33.

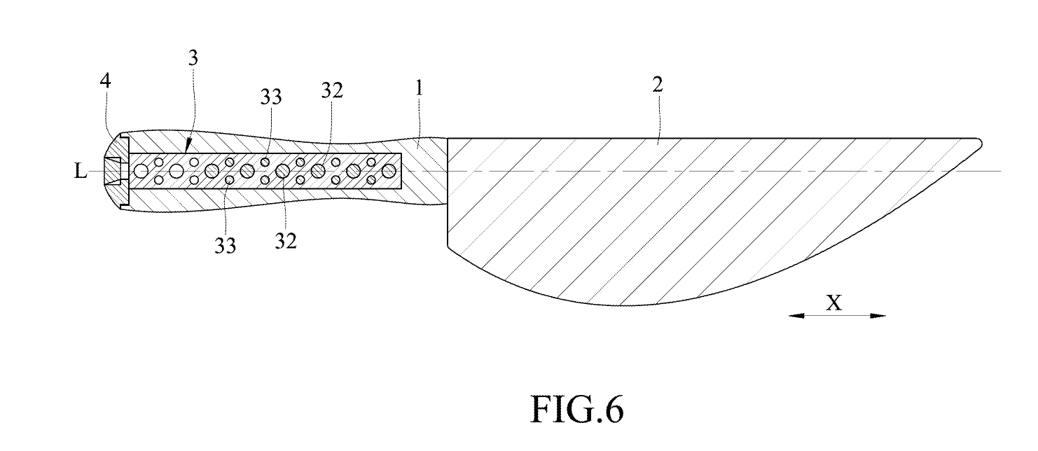

Referring to FIGS. 1, 3 and 6, in this embodiment, each of the primary counterweight members 32 is heavier than each of the secondary counterweight members 33 in weight. Each of the primary and secondary counterweight members 32, 33 is of a spheroid, a cube or others.

In this embodiment, the primary counterweight members 32 are disposed to be located on the axis (L). The secondary counterweight members 33 are disposed to permit the axis (L) to extend between two adjacent ones of the secondary counterweight members 33. The two adjacent ones of the secondary counterweight members 33 are interposed between two adjacent ones of the primary counterweight members 32.

Referring to FIGS. 1, 4 and 5, in assembly, the primary counterweight members 32 are disposed respectively in the first primary recessed halves 313 or the second primary recessed halves 315, and the secondary counterweight members 33 are disposed respectively in the first secondary recessed halves 314 or the second secondary recessed halves 316. Subsequently, the first and second mating surfaces 317, 318 of the first and second halves 311, 312 are mated with each other to insert the first and second halves 311, 312 into the accommodation chamber 14. The end cap 4 is finally disposed on the rear end 13 of the handle 1 to enclose the accommodation chamber 14.

Each of the primary and secondary counterweight members 32, 33 may be in magnetically attractive or snap-fit engagement with a respective one of the first and second halves 311, 312 so as to be removably disposed on the base seat 31. Likewise, the first and second halves 311, 312 may be in magnetically attractive or snap-fit engagement with each other to form the base seat 31.

With reference to FIGS. 1, 3 and 6, after the kitchen knife has been used for a long period of time, the center of gravity of the kitchen knife will move rearwardly due to frequent sharpening of the cutting edge 21. The user can adjust the weight and weight distribution of the kitchen knife by moving out the base seat 31 from the accommodation chamber 14 to remove the primary and secondary counterweight members 32, 33 from the base seat 31.

As illustrated, by varying the numbers and positions of the primary and secondary counterweight members 32, 33 on the base seat 31, the weight and weight distribution of the kitchen knife can be adjusted so as to suit the user's requirement. With the secondary counterweight members 33 which are lighter than the primary counterweight members 32, a micro-adjustment of the center of gravity of the kitchen knife can be easily performed. Moreover, the structure of the kitchen knife according to this disclosure is simple and assembly thereof is convenient

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A kitchen knife comprising:
a hollow handle having a surrounding wall which surrounds an axis in a longitudinal direction to have opposite front and rear ends, and which has an inner wall surface that defines an accommodation chamber therein;
a blade connected to said front end of said handle and having a cutting edge which faces downwardly; and
a counterweight unit pressed fit in said accommodation chamber, and including a base seat which extends in the longitudinal direction to be in frictional engagement with said inner wall surface, and a plurality of primary counterweight members which are removably disposed on said base seat and which are spaced apart from each other in the longitudinal direction.

2. The kitchen knife as claimed in claim 1, wherein said base seat has first and second halves each extending in the longitudinal direction, said first and second halves respectively having first and second mating surfaces which confront each other in a transverse direction that is transverse to the longitudinal direction, and which respectively have a plurality of first primary recessed halves that are spaced apart from each other in the longitudinal direction and a plurality of second primary recessed halves that are spaced apart from each other in the longitudinal direction, each pair of said first and second primary recessed halves being disposed to mate with each other so as to corporately define a primary recess for accommodating a respective one of said primary counterweight members.

3. The kitchen knife as claimed in claim 2, wherein said counterweight unit further includes a plurality of secondary counterweight members which are removably disposed on said base seat, which are spaced apart from each other in the longitudinal direction, and which are alternately arranged with said primary counterweight members.

4. The kitchen knife as claimed in claim 3, wherein said first and second mating surfaces of said first and second halves respectively have a plurality of first secondary recessed halves which are spaced apart from said first primary recessed halves and a plurality of second secondary recessed halves which are spaced apart from said second primary recessed halves, each pair of said first and second secondary recessed halves being disposed to mate with each other so as to corporately define a secondary recess for accommodating a respective one of said secondary counterweight members.

5. The kitchen knife as claimed in claim 4, wherein two adjacent ones of said secondary counterweight members are interposed between two adjacent ones of said primary counterweight members.

6. The kitchen knife as claimed in claim 5, wherein said primary counterweight members are disposed to be located on the axis.

7. The kitchen knife as claimed in claim 6, wherein said secondary counterweight members are disposed to permit the axis to extend between said two adjacent ones of said secondary counterweight members.

8. The kitchen knife as claimed in claim 7, wherein each of said primary counterweight members is heavier than each of said secondary counterweight members in weight.

9. The kitchen knife as claimed in claim 8, wherein each of said primary and secondary counterweight members is of a spheroid.

10. The kitchen knife as claimed in claim 1, further comprising an end cap which is disposed on said rear end of said handle to enclose said accommodation chamber.
